(19) United States
(12) Patent Application Publication
(10) Pub. No.: US 2016/0110665 A1
(43) Pub. Date: Apr. 21, 2016

(54) PREDICTION OF PARAMETER VALUES IN PROJECT SYSTEMS

(71) Applicant: SUBHOBRATA DEY, BANGALORE (IN)

(72) Inventor: SUBHOBRATA DEY, BANGALORE (IN)

(21) Appl. No.: 14/519,316

(22) Filed: Oct. 21, 2014

(51) Int. Cl. G06Q 10/06

(52) U.S. Cl. CPC G06Q 10/06313

(57) ABSTRACT

A training dataset input including user-defined parameters for a project is received in first set of nodes in a project system. The first set of nodes is initialized with pre-defined bias values. Pre-defined weights are associated with edges connecting the first set of nodes and a second set of nodes. Output of the first set of nodes is generated by providing the user-defined parameters as input to activation function in the first set of nodes. Output of the second set of nodes is generated by providing a first weighted sum of inputs to activation function in the second set of nodes. Output of the final node is computed as a predicted parameter value by providing a second weighted sum of inputs to a derivative of activation function in the final node. The predicted parameter value is displayed in a user interface in the project system.

### BACKGROUND

In enterprise solutions like project systems, project managers plan and estimate detailed project activities such as resource planning, time management, task dependency evaluation, etc. These estimates help in projecting project performance and progress. Various techniques of measurement of project performance and progress are used in the project systems. In most of these techniques various project parameters are used. These project parameters are typically dependent upon or are influenced by varying factors associated with a project. In some scenario, these varying factors in various combinations influence the estimated parameters of project systems. However, the estimated parameters of project systems are manually determined and not based on analytics on the various influencing parameters.

### BRIEF DESCRIPTION OF THE DRAWINGS

The claims set forth the embodiments with particularity. The embodiments are illustrated by way of examples and not by way of limitation in the figures of the accompanying drawings in which like references indicate similar elements. Various embodiments, together with their advantages, may be best understood from the following detailed description taken in conjunction with the accompanying drawings.

FIG. 1 is a block diagram illustrating an example environment for prediction of parameter values in project systems, according to one embodiment.

FIG. 2 illustrates a user interface of a project system to specify user-defined parameters, according to one embodiment.

FIG. 3 illustrates a user interface of a project system displaying input dataset including user-defined parameter values, according to one embodiment.

FIG. 4 illustrates an acyclic graph network to predict project parameters, according to one embodiment.

FIG. 5 illustrates an acyclic graph network to implement a training dataset input and predict project parameters, according to one embodiment.

FIG. 6 illustrates a graph representing error measurement based on varying training dataset input size, according to one embodiment.

FIG. 7A and FIG. 7B is a combined flow diagram illustrating process of predicting parameter values in project systems, according to one embodiment.

FIG. 8 is a block diagram illustrating an exemplary computer system, according to one embodiment.

### DETAILED DESCRIPTION

Embodiments of techniques for prediction of parameter values in project systems are described herein. In the following description, numerous specific details are set forth to provide a thorough understanding of the embodiments. A person of ordinary skill in the relevant art will recognize, however, that the embodiments can be practiced without one or more of the specific details, or with other methods, components, materials, etc. In some instances, well-known structures, materials, or operations are not shown or described in detail.

Reference throughout this specification to “one embodiment”, “this embodiment” and similar phrases, means that a particular feature, structure, or characteristic described in connection with the embodiment is included in at least one of the one or more embodiments. Thus, the appearances of these phrases in various places throughout this specification are not necessarily all referring to the same embodiment. Furthermore, the particular features, structures, or characteristics may be combined in any suitable manner in one or more embodiments.

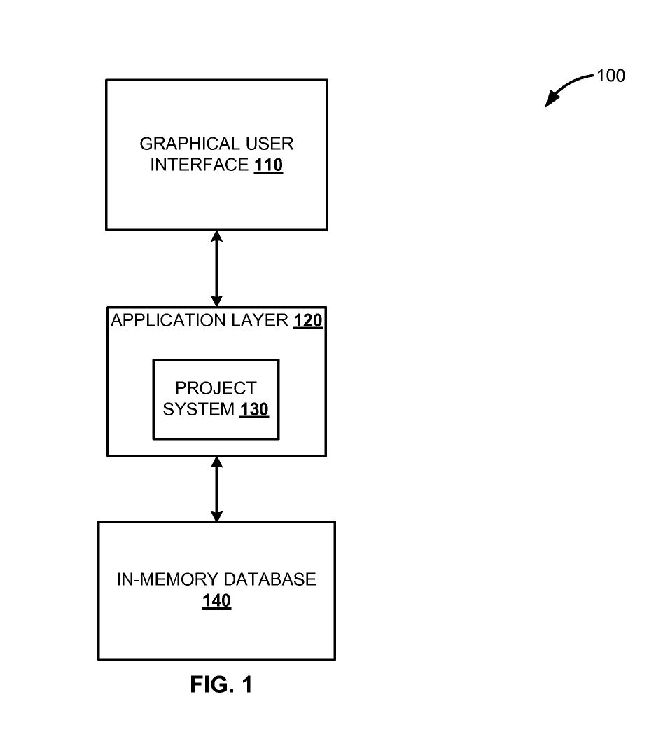

FIG. 1 is a block diagram illustrating example environment 100 for automatic prediction of parameter values in project systems, according to one embodiment. The environment 100 as shown contains graphical user interface 110 associated with project system 130, application layer 120 running project system 130 application, and in-memory database 140. Merely for illustration, only representative number and types of systems are shown in FIG. 1. Other environments may contain more instances of project systems and in-memory databases, both in number and type, depending on the purpose for which the environment is designed.

Application layer 120 may include one or more application servers that run application programs like project system 130. The application layer 120 communicates with presentation components such as a graphical user interface 110 associated with the project system 130 and in-memory database 140. Typically, a project involves tasks that are complex, goal oriented, time bound and quality controlled. A project may involve a number of tasks and for completion of the project these tasks have to be completed. There are various techniques in project planning that can be used to manage tasks in project system 130. Project can be planned using the graphical user interface 110 associated with the project system 130. Tasks associated with the project can be defined or created in the graphical user interface 110.

Using appropriate option in the graphical user interface 110 associated with the project system 130, a request for prediction of parameter values is sent to in-memory database 140 for performing predictive analytics on data available in the in-memory database 140. This predictive analytics results in predicted parameter values, and displayed in the graphical user interface 110. A connection is established from the project system 130 of the application layer 120 to the in-memory database 140. The connectivity between the project system 130 and the in-memory database 140 may be implemented using standard protocols such as Transmission Control Protocol (TCP) and/or Internet Protocol (IP), etc. The project system 130 can be executed as web application on any browser in desktops.

Among the various techniques in project management that can be used in project system 130, a project management technique ‘Earned value management (EVM)’ may be considered for measuring project performance and progress. EVM enables project managers to measure project performance using a systematic process to find variances in projects based on the comparison of work performed and work planned. EVM is used on the cost and project schedule and are used in project forecasting. Using EVM technique, project managers estimate the planned earned values or budgeted cost of work schedule (BCWS) for time units such as calendar weeks, months, or years, etc., for various objects like activities, tasks, etc., in the projects. The planned earned values are later used for comparing with actual data such as actual earned values or Budgeted Cost of Work Performed (BCWP), actual cost, etc., to track the project progress. Planned earned values or Budgeted Cost of Work Schedule (BCWS) is the sum of budgets for all work scheduled to be accomplished for a given time period, and it depends on various factors such as schedule, cost, etc. Using the project system 130, planned earned values or BCWS are analytically predicted. The predictive analytics is performed on similar objects which are stored in archived projects, and the predicted parameter values are compared with actual values, and this result is used on subsequent objects.

Consider a scenario of predicting earned values for a project where the earned values are dependent on various user-defined parameters such as currency, actual cost, percentage of completion (POC) and time unit, etc.

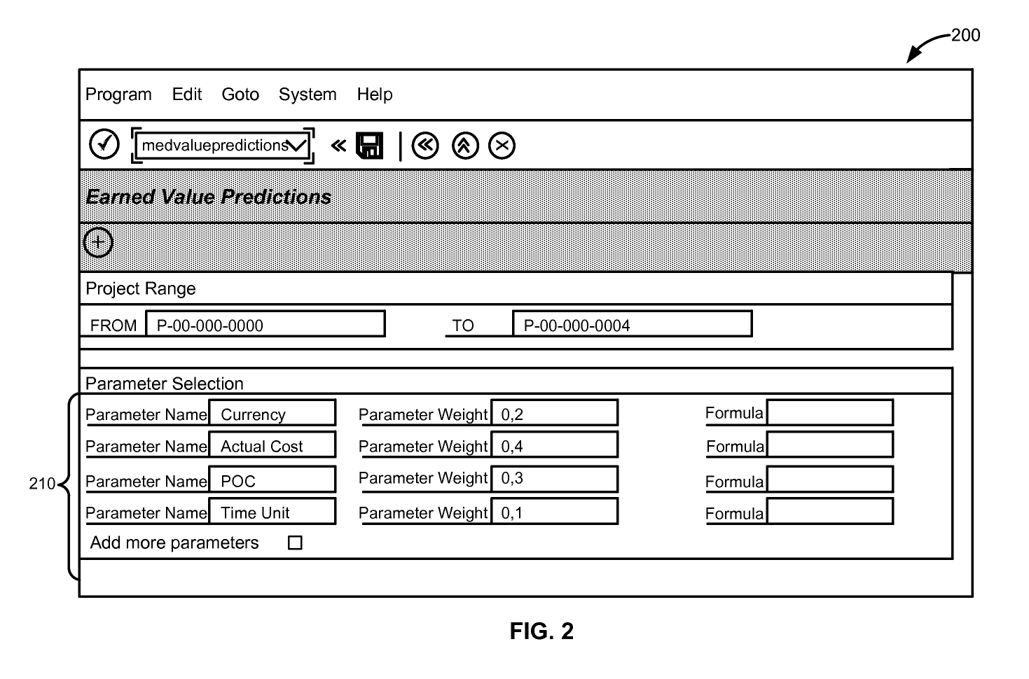

FIG. 2 illustrates user interface 200 of a project system to specify user-defined parameters, according to one embodiment. In the example considered above, user-defined parameters currency, actual cost, POC and time unit are specified as shown in 210. The user-defined parameters can be associated with weights as shown in the parameter weight section. Similar projects or tasks are identified from archived projects and input datasets including these user-defined parameters are retrieved for predictive analytics.

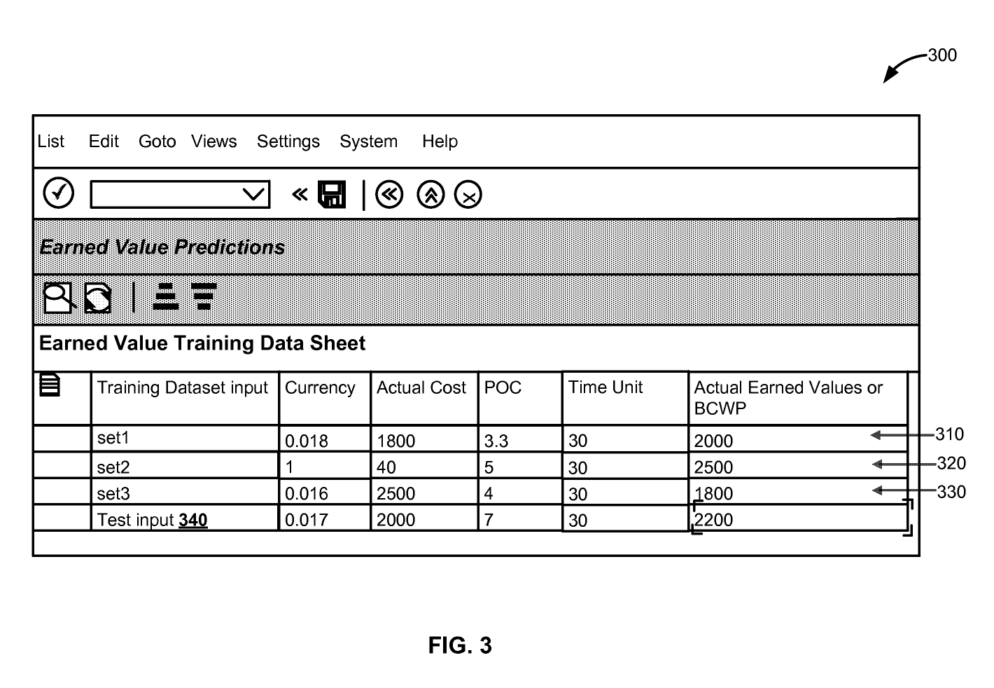

FIG. 3 illustrates user interface 300 of a project system displaying input dataset including user-defined parameter values, according to one embodiment. First training dataset input (set1) with user-defined parameters currency with a value of ‘0.018’, actual cost with a value of ‘1800’, percentage of completion with a value of ‘3.3’ and time unit with a value of ‘30’ are retrieved from archived projects and displayed as shown in 310. The actual earned value for the first training dataset input (set1) is ‘2000’. Second training dataset input (set2) with user-defined parameters currency with a value of 1, actual cost with a value of ‘40’, percentage of completion with a value of ‘5’ and time unit with a value of ‘30’ are retrieved from archived projects and displayed as shown in 320. The actual earned value for the second training dataset input (set2) is ‘2500’. Third training dataset input (set3) with user-defined parameters currency with a value of ‘0.016’, actual cost with a value of ‘2500’, percentage of completion with a value of ‘4’ and time unit with a value of ‘30’ are retrieved from archived projects and displayed as shown in 330. The actual earned value for the third training dataset input (set3) is ‘1800’. Based on these training dataset inputs and the actual earned values planned earned value for test input 340 is estimated or predicted.

To predict planned earned value or BCWS for a test input, various artificial neural network algorithms such as back propagation algorithm can be used. An acyclic graph network is selected to implement the back propagation algorithm.

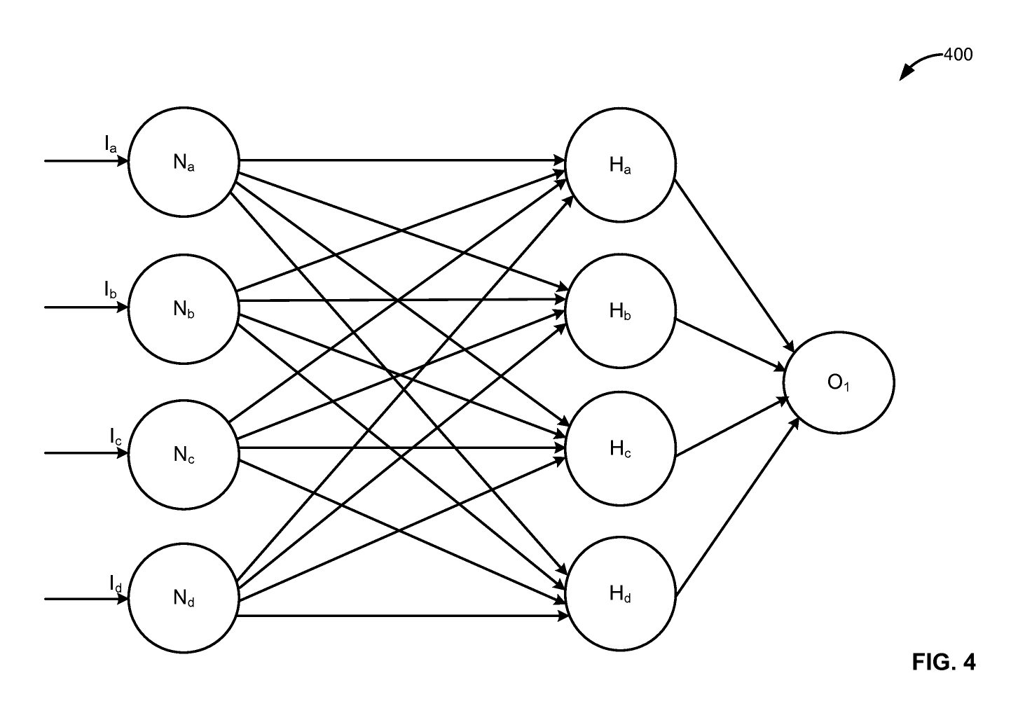

FIG. 4 illustrates an acyclic graph network to predict parameter values, according to one embodiment. The acyclic graph network 400 is a directed acyclic graph formed by a collection of nodes and directed edges. Nodes can be input nodes, hidden nodes, output nodes or final nodes. An edge connects one node to another and there is no loop or cycle formed in the acyclic graph 400. The first set of nodes Nₐ, N_{b}, N_{c} and N_{d} represents input nodes. These input nodes are connected to a second set of nodes referred to as hidden nodes Hₐ, H_{b}, H_{c} and H_{d}. The first set of nodes is connected to the second set of nodes via directed edges. A node in the acyclic graph network has an in-edge that comes toward the node and an out-edge that goes outward from the node. The individual hidden node Hₐ, H_{b}, H_{c} and H_{d} receives input from the input nodes Nₐ, N_{b}, N_{c} and N_{d}. The individual input nodes have its effect on individual hidden nodes. The hidden nodes are connected to an output node or final node via directed edges. The individual nodes have an activation function associated with it. The activation function for the individual nodes is chosen to be a standard sigmoid function as shown below:

$$activation function f ( x ) = \frac{1}{1 + {e}^{- x}} ,$$

where x represents the value of input.

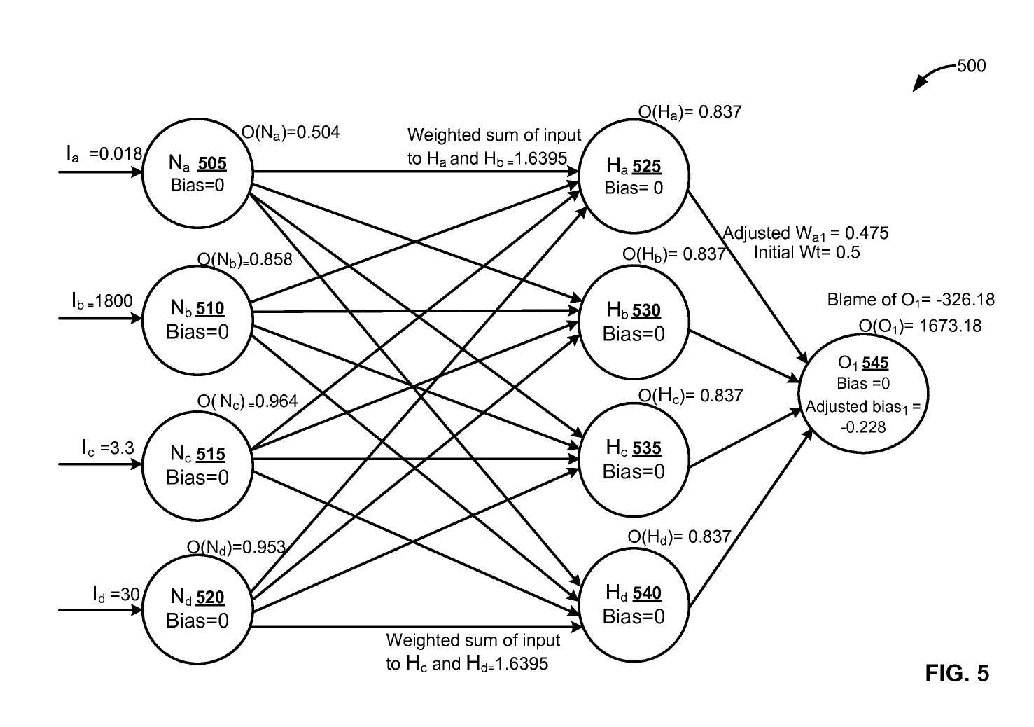

FIG. 5 illustrates an acyclic graph network to implement a training dataset input and predict project parameters, according to one embodiment. Consider an example of the first training dataset input (set1) with user-defined parameters currency with a value of ‘0.018’, actual cost with a value of ‘1800’, percentage of completion (POC) with a value of ‘3.3’ and time unit with a value of ‘30’, as shown in 310 of FIG. 3. This first training dataset input (set1) is provided as input to the acyclic graph 400. In the acyclic graph network 500 input to node Nₐ 505 is Iₐ with a value of ‘0.018’ (currency), N_{b} 510 is I_{b} with a value of ‘1800’ (cost), N_{c} 515 is I_{c} with a value of ‘3.3’ (percentage of completion) and N_{d} 520 is I_{d} with a value of ‘30’ (time unit). The directed edge in the acyclic graph network has a weight associated with it, and the individual nodes in the network have a bias associated with it. Bias of a node is a measure indicating bias or variation in the input/output of the training datasets.

The first training dataset input (set1) is provided as input to the acyclic graph network 500 and output of the acyclic graph network 500 is generated. Input Iₐ=‘0.018’ is provided to node N_{α} 505, I_{b}=‘1800’ is provided to node N_{510,} I_{c}=‘3.3’ is provided to node N_{c} 515 and I_{d}=‘30’ is provided to node N_{d} 520. Output of node Nₐ 505 i.e. O(Nₐ) is generated by providing the input Iₐ=‘0.018’ to the activation function in the input node N_{α} 505. Output of node Nₐ 505 i.e. O(Nₐ) is generated as 1/(1+ê−0.018)=‘0.504’. Output of node N_{b} 510 i.e. O(N_{b}) is generated by providing the input I_{b}=‘1800’ to the activation function in the input node N_{b} 510. Output of node N_{b} 510 i.e. O(N_{b}) is generated as 1/(1+ê−1.8)=‘0.858’ (this value is scaled down by a factor of 1000 for better approximation). Output of node N_{c} 515 i.e. O(N_{c}) is generated by providing the input I_{c}=‘3.3’ to the activation function in the input node N_{c} 515. Output of node N_{c} 515 i.e. O(N_{c}) is generated as 1/(1+ê−3.3)=‘0.964’. Output of node N_{d} 520 i.e. O(N_{d}) is generated by providing the input I_{d}=‘30’ to the activation function in the input node N_{d} 520. Output of node N_{d} 520 i.e. O(N_{d}) is generated as 1/(1+ê−3)=‘0.953’ (this value is scaled down by a factor of 10 for better approximation).

Based on these calculated output of nodes O(Nₐ), O(N_{b}), O(N_{c}) and O(N_{d}), weighted sum of inputs to hidden nodes Hₐ 525, H_{b} 530, Hₑ 535 and H_{d} 540 are computed and then output of hidden nodes Hₐ 525, H_{b} 530, H_{c} 535 and H_{d} 540 are generated as O(Hₐ), O(H_{b}), O(H_{c}) and O(H_{d}). Hidden nodes Hₐ 525, H_{b} 530, Hₑ 535 and H_{d} 540 have weighted directed in-edges coming from various nodes Nₐ 505, N_{b} 510, N_{c} 515 and N_{d} 520. Accordingly weighted sum of inputs to hidden nodes or first weighted sum of inputs is computed using the equation shown below:

Weighted sum of inputs to nodes O(Hj) =Wₐⱼ*O(Nₐ)+W_{bj}*O(N_{b})+W_{cj}*O(N_{c})+W_{dj}*O(N_{d})+bⱼ

where Wₐⱼ, W_{bj}, W_{cj} and W_{dj} represents weight of the in-edges coming to a hidden node Hⱼ from nodes Nₐ 505, N_{b} 510, N_{c} 515 and N_{d} 520, bⱼ represents bias and is initially considered as ‘0’. Initially assigned bias values can be any pre-defined bias value. Let the initial weights or pre-defined weights of Wₐⱼ, W_{bj}, W_{cj} and W_{dj} be ‘0.5’. Weighted sum of inputs to hidden node Hₐ 525 is calculated as 0.5*0.504+0.5*0.858+0.5*0.964+0.5*0.953+0=‘1.6395’. Weighted sum of inputs to hidden node H_{b} 530 is calculated as 0.5*0.504+0.5*0.858+0.5*0.964+0.5*0.953+0=‘1.6395’, weighted sum of inputs to hidden node Hₑ 535 is calculated as 0.5*0.504+0.5*0.858 +0.5*0.964+0.5*0.953+0=‘1.6395’, and weighted sum of inputs to hidden node H_{d} 540 is calculated as 0.5*0.504+0.5*0.858+0.5*0.964+0.5*0.953+0=‘1.6395’. Consider weighted sum of inputs to hidden node Hₐ ‘1.6395’ and calculate output of hidden node Hₐ i.e. O(Hₐ) as (1/1+ê−1.6395)=‘0.837’. Consider weighted sum of inputs to hidden node H_{b} ‘1.6395’ and calculate output of hidden node H_{b} i.e. O(H_{b}) as (1/1+ê−1.6395)=‘0.837’. Consider weighted sum of inputs to hidden node H_{c} ‘1.6395’ and calculate output of hidden node H_{c} i.e. O(H_{c}) as (1/1+ê−1.6395)=‘0.837’. Similarly, consider weighted sum of inputs to hidden node O(H_{d}) ‘1.6395’ and calculate output of hidden node H_{d} i.e. O(H_{d}) as (1/1+ê−1.6395)=‘0.837’.

Finally, weighted sum of inputs to node O₁ 545 and output of node O₁ 545 are computed based on the outputs of hidden nodes O(Hₐ), O(H_{b}), O(H_{c}) and O(H_{d}). Node O₁ 545 has in-edges from hidden nodes Hₐ 525, H_{b} 530, H_{c} 535 and H_{d} 540. Weighted sum of inputs to final node O₁ 545 or second weighted sum of inputs is computed as 0.5*0.837+0.5*0.837+0.5*0.837+0.5*0.837+0=‘1.674’. Since some of the values were scaled down by a factor of 10 and 1000, therefore the computed output of node O₁ i.e. O(O₁) is applied in equation

$$x = ln ( \frac{1}{( \frac{1}{o ( {o}_{1} ) - 1} )} )$$

as ln(1/(1/0.842−1))*1000 to get O(O₁) as ‘1673.18’. The output of node O₁ i.e. O(O₁) ‘1673.18’ is the estimated planned earned value or BCWP.

For the first training dataset input (set1) provided as input to the acyclic graph network 500, output of the acyclic graph network i.e. estimated planned earned value or BCWP is ‘1673.18’ as computed above. Whereas for the first training dataset input (set1) the actual earned value or Budgeted cost of work schedule (BCWS) is ‘2000’ as shown in 310 of FIG. 3. There is a difference between the predicted value BCWP ‘1673.18’ and the actual value BCWS ‘2000’. This difference between BCWP-BCWS is referred to as blame which indicates the error in estimation. Blame is used to calculate adjusted weights and adjusted bias to minimize the error in prediction for the subsequent training dataset inputs. When these adjusted weights and adjusted bias are used in the acyclic graph network, the acyclic graph network is trained to predict parameter values with minimum or no error. To compute blame and to train the acyclic graph network consider the first training dataset input (set1) with the value of BCWS as ‘1673.18’, value of BCWP as ‘2000’, initial bias as ‘0’ and initial weight as ‘0.5’. Blame is calculated in opposite order in the acyclic network graph 500. Blame of node O₁ 545 is calculated as ‘1673.18’ (BCWS)−‘2000’ (BCWP)=‘−326.18’. Based on the calculated blame, adjusted weights of edges and adjusted bias of nodes are automatically calculated. Weights of the directed edges in the acyclic graph network are adjusted based on the formula:

adjusted weight wᵢⱼ=wᵢⱼ+r*eⱼ*Aⱼ¹(Iⱼ)*O₁,

where wᵢⱼ is the weight of an edge connecting nodes i and j, r is the learning rate for the algorithm and it is considered as ‘0.7’ as this value is proved to be a best possible approximation for the learning rate, Iⱼ is the input to the node j, eⱼ is the blame of node j, Aⱼ¹ is the derivative of node j's activation function represented as a derivative of sigmoid function and be represented as:

$$derivation of activation function {f}^{\vert} ( x ) = \frac{{e}^{x}}{{( 1 + {e}^{x} )}^{2}} ,$$

where x is a value input to the derivative of activation function. Bias of the nodes in the acyclic graph network is adjusted based on the formula:

adjusted biasᵢ=biasⱼ+r*eⱼ,

where biasⱼ is bias of node j, r is the learning rate for the algorithm and it is considered as ‘0.7’ as sown above, and eⱼ is the blame of node j.

For the final node O₁ adjusted weight and adjusted bias are computed. Adjusted weight Wₐ₁ of the edge connecting Hₐ and O₁ is computed as 0.5+0.7*(−0.326)*(ê1.673/(1+ê1.673) ̂2)*0.837=‘0.475’. Similarly, for the node O₁ adjusted bias bias₁ is computed as 0+0.7* (−0.326)=‘−0.228’. Similarly, adjusted weights are computed between node H_{b} and O₁, H_{c} and O₁ and H_{d} and O₁, and adjusted biases are computed for nodes H_{b}, H_{c} and H_{d}. Similarly, adjusted weights and adjusted biases are computed for the nodes Nₐ, N_{b}, N_{c} and N_{d}. These adjusted weights and adjusted bias values are used for the second training dataset input (set2) in the acyclic graph network, and output of individual nodes, new adjusted weights and new adjusted bias values are computed to be applied on the third training dataset input set (set3). Adjusted weights and adjusted bias values are iteratively computed for individual training dataset input and the acyclic graph network is trained based on the iteratively computed adjusted weights of edges and adjusted bias of nodes.

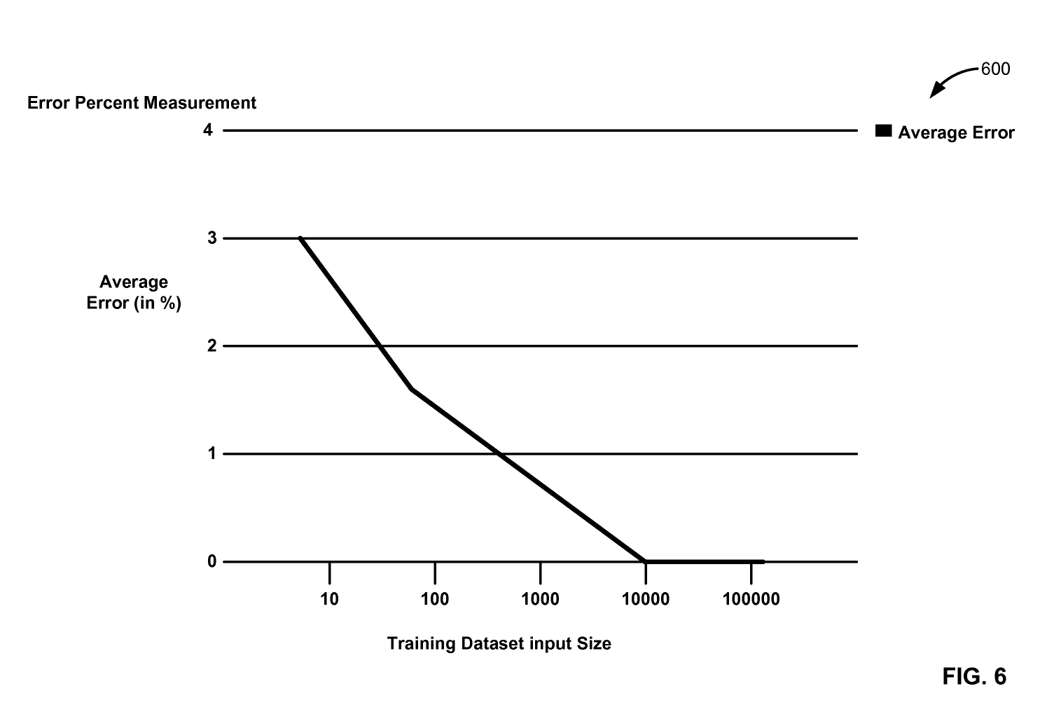

FIG. 6 illustrates a graph representing error measurement based on varying training dataset input size, according to one embodiment. Sum of squares error (SSE) of the acyclic graph network for the training dataset input is sum of squares of difference between predicted value and actual value i.e., the difference between BCWP and BCWS. This is represented in a generic formula as:

SSE=Σ(Yᵢ−Zᵢ)²,

where Yᵢ is the set of desired output and Zᵢ is the set of actual output for a specific input. The back propagation learning algorithm minimizes the sum of squares error. When the size of training dataset input is ‘10’ the average error percentage is ‘3%’, when the size of training dataset input is ‘100’ the average error percentage is ‘1.7%’, when the size of training dataset input is increased to ‘1000’ the average error percentage is ‘1%’ and when the size of training dataset input is increased further to ‘10000’ the average error percentage is reduced to ‘0%’. As the number of training dataset input size increase, the average error or the SSE decreases and reaches ‘0’ as shown in graph 600.

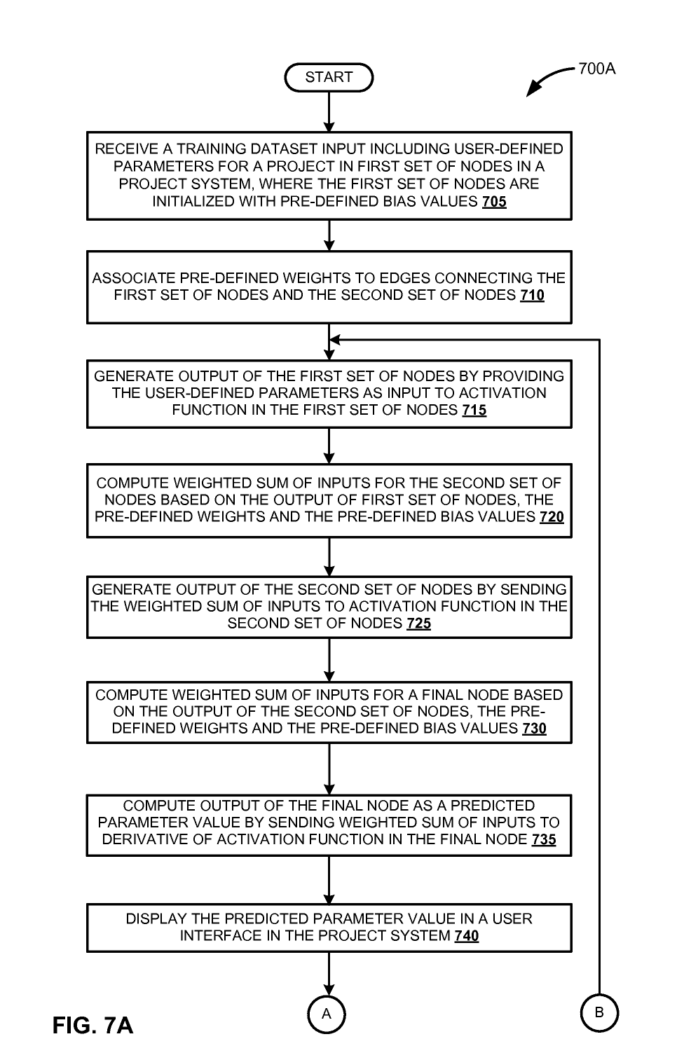

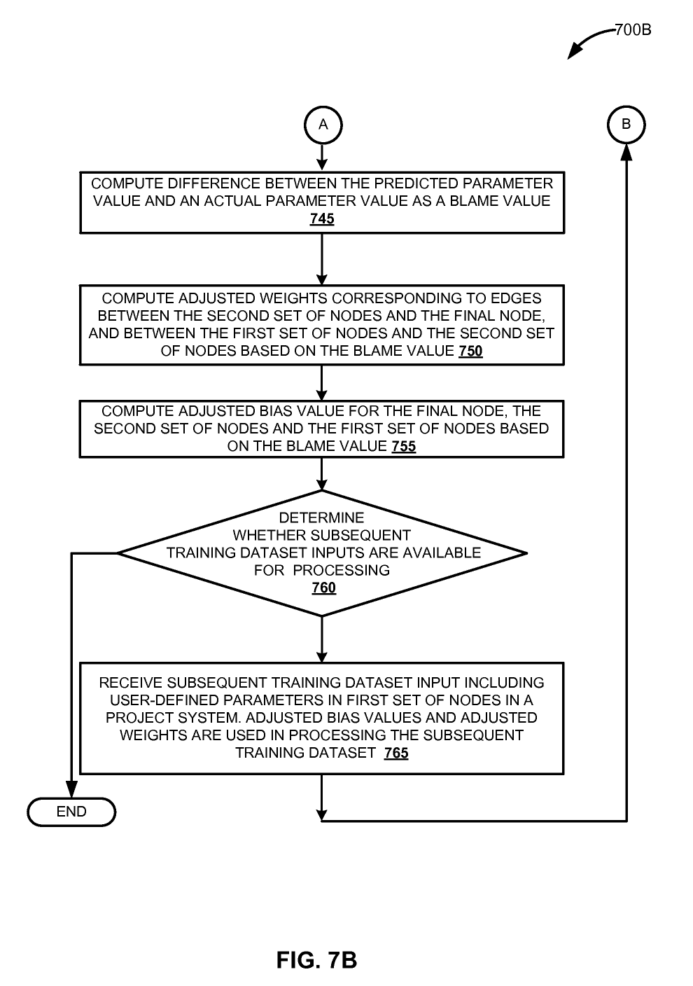

FIG. 7A and FIG. 7B is a combined flow diagram illustrating process parts 700A and 700B of predicting parameter values in project systems, according to one embodiment. At 705, a training dataset input including user-defined parameters for a project is received in a user interface associated with a project system. The user-defined parameters are received at first set of nodes of an acyclic network graph. The first set of nodes is initialized with pre-defined bias values. At 710, edges connecting the first set of nodes and second set of nodes are associated with pre-defined weights. At 715, the user-defined parameters are provided as input to activation function in the first set of nodes to generate output of the first set of nodes. At 720, based on the generated output of the first set of nodes, the pre-defined weights and the pre-defined bias values, weighted sum of inputs for the second set of nodes is computed. At 725, the weighted sum of inputs is provided to activation function in the second set of nodes to generate output of the second set of nodes. At 730, based on the output of the second set of nodes, the pre-defined weights and the pre-defined bias values, weighted sum of inputs for the final node is computed. At 735, the weighted sum of inputs of the final node is provided to derivative of activation function in the final node to generate output of the final node as a predicted parameter value. At 740, the predicted parameter value is displayed in a user interface in the project system.

At 745, difference between the predicted parameter value and an actual parameter value of the project is computed as a blame value. At 750, based on the blame value, adjusted weights corresponding to edges between the second set of nodes and the final node, and adjusted weights corresponding to edges between the first set of nodes and the second set of nodes are computed. At 755, based on the blame value, adjusted bias values are computed for the final node, the second set of nodes and the first set of nodes. At 760, it is determined whether subsequent training dataset inputs are available for processing. Upon determining that the subsequent training dataset input is not available for processing, the process ends. At 765, upon determining that subsequent training dataset inputs are available for processing, the subsequent training dataset input including user-defined parameters is received at the first set of nodes. The adjusted bias values and the adjusted weights are used to process the subsequent training dataset input in reference to steps 715 to 735. For this subsequent training dataset input new blame, new adjusted weights and new adjusted bias values are computed in reference to steps 745 to 755. The new blame, the new adjusted weights and the new bias values are used to process a subsequent training dataset input. The acyclic graph network is trained based on the iteratively computed blame, adjusted weights and adjusted bias values.

The various embodiments described above have a number of advantages. The estimated outcome parameters of project systems are predicted based on the training dataset input. With increasing number of training dataset input size the error percentage is reduced to zero. The parameter values are predicted based on analytics on the various influencing project parameters, thereby providing accurate prediction. The influencing project parameters are retrieved from archived projects, accordingly the network is trained with actual archived project inputs.

Some embodiments may include the above-described methods being written as one or more software components. These components, and the functionality associated with each, may be used by client, server, distributed, or peer computer systems. These components may be written in a computer language corresponding to one or more programming languages such as, functional, declarative, procedural, object-oriented, lower level languages and the like. They may be linked to other components via various application programming interfaces and then compiled into one complete application for a server or a client. Alternatively, the components maybe implemented in server and client applications. Further, these components may be linked together via various distributed programming protocols. Some example embodiments may include remote procedure calls being used to implement one or more of these components across a distributed programming environment. For example, a logic level may reside on a first computer system that is remotely located from a second computer system containing an interface level (e.g., a graphical user interface). These first and second computer systems can be configured in a server-client, peer-to-peer, or some other configuration. The clients can vary in complexity from mobile and handheld devices, to thin clients and on to thick clients or even other servers.

The above-illustrated software components are tangibly stored on a computer readable storage medium as instructions. The term “computer readable storage medium” should be taken to include a single medium or multiple media that stores one or more sets of instructions. The term “computer readable storage medium” should be taken to include any physical article that is capable of undergoing a set of physical changes to physically store, encode, or otherwise carry a set of instructions for execution by a computer system which causes the computer system to perform any of the methods or process steps described, represented, or illustrated herein. Examples of computer readable storage media include, but are not limited to: magnetic media, such as hard disks, floppy disks, and magnetic tape; optical media such as CD-ROMs, DVDs and holographic devices; magneto-optical media; and hardware devices that are specially configured to store and execute, such as application-specific integrated circuits (ASICs), programmable logic devices (PLDs) and ROM and RAM devices. Examples of computer readable instructions include machine code, such as produced by a compiler, and files containing higher-level code that are executed by a computer using an interpreter. For example, an embodiment may be implemented using Java, C++, or other object-oriented programming language and development tools. Another embodiment may be implemented in hard-wired circuitry in place of, or in combination with machine readable software instructions.

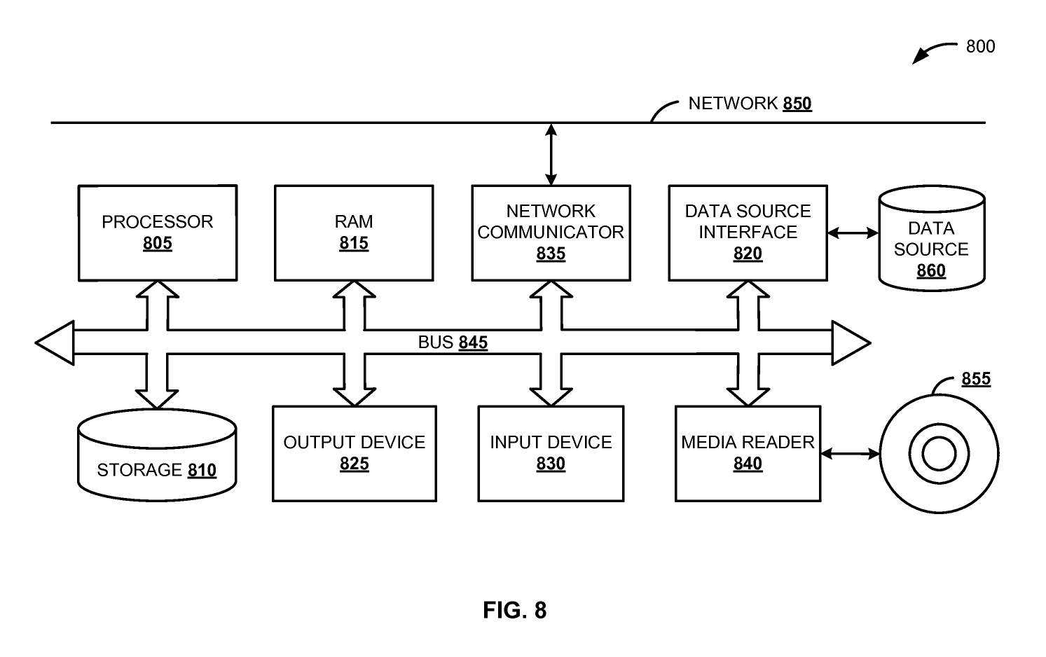

FIG. 8 is a block diagram illustrating an exemplary computer system, according to one embodiment. The computer system 800 includes a processor 805 that executes software instructions or code stored on a computer readable storage medium 855 to perform the above-illustrated methods. The computer system 800 includes a media reader 840 to read the instructions from the computer readable storage medium 855 and store the instructions in storage 810 or in random access memory (RAM) 815. The storage 810 provides a large space for keeping static data where at least some instructions could be stored for later execution. The stored instructions may be further compiled to generate other representations of the instructions and dynamically stored in the RAM 815. The processor 805 reads instructions from the RAM 815 and performs actions as instructed. According to one embodiment, the computer system 800 further includes an output device 825 (e.g., a display) to provide at least some of the results of the execution as output including, but not limited to, visual information to users and an input device 830 to provide a user or another device with means for entering data and/or otherwise interact with the computer system 800. The output devices 825 and input devices 830 could be joined by one or more additional peripherals to further expand the capabilities of the computer system 800. A network communicator 835 may be provided to connect the computer system 800 to a network 850 and in turn to other devices connected to the network 850 including other clients, servers, data stores, and interfaces, for instance. The modules of the computer system 800 are interconnected via a bus 845. Computer system 800 includes a data source interface 820 to access data source 860. The data source 860 can be accessed via one or more abstraction layers implemented in hardware or software. For example, the data source 860 may be accessed by network 850. In some embodiments the data source 860 may be accessed via an abstraction layer, such as, a semantic layer.

A data source is an information resource. Data sources include sources of data that enable data storage and retrieval. Data sources may include databases, such as, relational, transactional, hierarchical, multi-dimensional (e.g., OLAP), object oriented databases, and the like. Further data sources include tabular data (e.g., spreadsheets, delimited text files), data tagged with a markup language (e.g., XML data), transactional data, unstructured data (e.g., text files, screen scrapings), hierarchical data (e.g., data in a file system, XML data), files, a plurality of reports, and any other data source accessible through an established protocol, such as, Open Data Base Connectivity (ODBC), produced by an underlying software system (e.g., ERP system), and the like. Data sources may also include a data source where the data is not tangibly stored or otherwise ephemeral such as data streams, broadcast data, and the like. These data sources can include associated data foundations, semantic layers, management systems, security systems and so on.

In the above description, numerous specific details are set forth to provide a thorough understanding of embodiments. One skilled in the relevant art will recognize, however that the embodiments can be practiced without one or more of the specific details or with other methods, components, techniques, etc. In other instances, well-known operations or structures are not shown or described in detail.

Although the processes illustrated and described herein include series of steps, it will be appreciated that the different embodiments are not limited by the illustrated ordering of steps, as some steps may occur in different orders, some concurrently with other steps apart from that shown and described herein. In addition, not all illustrated steps may be required to implement a methodology in accordance with the one or more embodiments. Moreover, it will be appreciated that the processes may be implemented in association with the apparatus and systems illustrated and described herein as well as in association with other systems not illustrated.

The above descriptions and illustrations of embodiments, including what is described in the Abstract, is not intended to be exhaustive or to limit the one or more embodiments to the precise forms disclosed. While specific embodiments of, and examples for, the one or more embodiments are described herein for illustrative purposes, various equivalent modifications are possible within the scope, as those skilled in the relevant art will recognize. These modifications can be made in light of the above detailed description. Rather, the scope is to be determined by the following claims, which are to be interpreted in accordance with established doctrines of claim construction.

What is claimed is:

1. A non-transitory computer-readable medium to store instructions, which when executed by a computer, cause the computer to perform operations comprising:
receive a training dataset input including user-defined parameters for a project in a first set of nodes in a project system, wherein the first set of nodes is initialized with pre-defined bias values;
associate pre-defined weights to edges connecting the first set of nodes and a second set of nodes;
generate output of the first set of nodes by providing the user-defined parameters as input to an activation function in the first set of nodes;
generate output of the second set of nodes by providing a first weighted sum of inputs to an activation function in the second set of nodes;
compute output of a final node as a predicted parameter value by providing a second weighted sum of inputs to a derivative of an activation function in the final node; and
display the predicted parameter value in a user interface in the project system.

2. The computer-readable medium of claim 1, further comprising instructions which when executed by the computer further causes the computer to:
compute the first weighted sum of inputs for the second set of nodes based on the output of the first set of nodes, the pre-defined weights and the pre-defined bias values.

3. The computer-readable medium of claim 1, further comprising instructions which when executed by the computer further causes the computer to:
compute the second weighted sum of inputs for a final node based on the output of the second set of nodes, the pre-defined weights and the pre-defined bias values.

4. The computer-readable medium of claim 1, further comprising instructions which when executed by the computer further causes the computer to:
compute difference between the predicted parameter value and an actual parameter value as a blame value.

5. The computer-readable medium of claim 1, further comprising instructions which when executed by the computer further causes the computer to:
compute adjusted weights corresponding to edges between the final node and the second set of nodes, and corresponding to edges between the first set of nodes and the second set of nodes based on the blame value.

6. The computer-readable medium of claim 1, further comprising instructions which when executed by the computer further causes the computer to:
compute adjusted bias value for the final node, the second set of nodes and the first set of nodes based on the blame value.

7. The computer-readable medium of claim 1, further comprising instructions which when executed by the computer further causes the computer to:
receive a subsequent training dataset input including user-defined parameters for a project in first set of nodes in a project system, wherein the first set of nodes are initialized with the adjusted bias values;
associate adjusted weights to edges connecting the first set of nodes and a second set of nodes;
generate output of the first set of nodes by providing the user-defined parameters as input to activation function in the first set of nodes;
generate output of the second set of nodes by providing a subsequent weighted sum of inputs to activation function in the second set of nodes;
compute output of the final node as a predicted parameter value by providing a subsequent weighted sum of inputs to a derivative of activation function in the final node; and
display the subsequent predicted parameter value in a user interface in the project system.

8. A computer-implemented method for prediction of parameter values, the method comprising:
receiving a training dataset input including user-defined parameters for a project in a first set of nodes in a project system, wherein the first set of nodes is initialized with pre-defined bias values;
associating pre-defined weights to edges connecting the first set of nodes and a second set of nodes;
generating output of the first set of nodes by providing the user-defined parameters as input to an activation function in the first set of nodes;
generating output of the second set of nodes by providing a first weighted sum of inputs to an activation function in the second set of nodes;
computing output of a final node as a predicted parameter value by providing a second weighted sum of inputs to a derivative of an activation function in the final node; and
displaying the predicted parameter value in a user interface in the project system.

9. The method of claim 8, further comprising instructions which when executed by the computer further causes the computer to:
computing the first weighted sum of inputs for the second set of nodes based on the output of the first set of nodes, the pre-defined weights and the pre-defined bias values.

10. The method of claim 8, further comprising instructions which when executed by the computer further causes the computer to:
computing the second weighted sum of inputs for a final node based on the output of the second set of nodes, the pre-defined weights and the pre-defined bias values.

11. The method of claim 8, further comprising instructions which when executed by the computer further causes the computer to:
computing difference between the predicted parameter value and an actual parameter value as a blame value.

12. The method of claim 8, further comprising instructions which when executed by the computer further causes the computer to:
computing adjusted weights corresponding to edges between the final node and the second set of nodes, and corresponding to edges between the first set of nodes and the second set of nodes based on the blame value.

13. The method of claim 8, further comprising instructions which when executed by the computer further causes the computer to:
computing adjusted bias value for the final node, the second set of nodes and the first set of nodes based on the blame value.

14. The method of claim 8, further comprising instructions which when executed by the computer further causes the computer to:
receiving a subsequent training dataset input including user-defined parameters for a project in first set of nodes in a project system, wherein the first set of nodes are initialized with the adjusted bias values;
associating adjusted weights to edges connecting the first set of nodes and a second set of nodes;
generating output of the first set of nodes by providing the user-defined parameters as input to activation function in the first set of nodes;
generating output of the second set of nodes by providing a subsequent weighted sum of inputs to activation function in the second set of nodes;
computing output of the final node as a predicted parameter value by providing a subsequent weighted sum of inputs to a derivative of activation function in the final node; display the subsequent predicted parameter value in a user interface in the project system.

15. A computer system for prediction of parameter values in project system, comprising:
a computer memory to store program code; and
a processor to execute the program code to:
receive a training dataset input including user-defined parameters for a project in a first set of nodes in a project system, wherein the first set of nodes is initialized with pre-defined bias values;
associate pre-defined weights to edges connecting the first set of nodes and a second set of nodes;
generate output of the first set of nodes by providing the user-defined parameters as input to an activation function in the first set of nodes;
generate output of the second set of nodes by providing a first weighted sum of inputs to an activation function in the second set of nodes;
compute output of a final node as a predicted parameter value by providing a second weighted sum of inputs to a derivative of an activation function in the final node; and
display the predicted parameter value in a user interface in the project system.

16. The system of claim 15, further comprising instructions which when executed by the computer further causes the computer to:
compute the first weighted sum of inputs for the second set of nodes based on the output of the first set of nodes, the pre-defined weights and the pre-defined bias values.

17. The system of claim 15, further comprising instructions which when executed by the computer further causes the computer to:
Compute the second weighted sum of inputs for a final node based on the output of the second set of nodes, the pre-defined weights and the pre-defined bias values.

18. The system of claim 15, further comprising instructions which when executed by the computer further causes the computer to:
compute difference between the predicted parameter value and an actual parameter value as a blame value.

19. The system of claim 15, further comprising instructions which when executed by the computer further causes the computer to:
compute adjusted weights corresponding to edges between the final node and the second set of nodes, and corresponding to edges between the first set of nodes and the second set of nodes based on the blame value; and
compute adjusted bias value for the final node, the second set of nodes and the first set of nodes based on the blame value.

20. The system of claim 15, further comprising instructions which when executed by the computer further causes the computer to:
receive a subsequent training dataset input including user-defined parameters for a project in first set of nodes in a project system, wherein the first set of nodes are initialized with the adjusted bias values;
associate adjusted weights to edges connecting the first set of nodes and a second set of nodes;
generate output of the first set of nodes by providing the user-defined parameters as input to activation function in the first set of nodes;
generate output of the second set of nodes by providing a subsequent weighted sum of inputs to activation function in the second set of nodes;
compute output of the final node as a predicted parameter value by providing a subsequent weighted sum of inputs to a derivative of activation function in the final node; and
display the subsequent predicted parameter value in a user interface in the project system.
